(19) United States
(12) Patent Application Publication
(10) Pub. No.: US 2026/0011480 A1
(43) Pub. Date: Jan. 8, 2026

(54) ELECTRONIC COMPONENT

(71) Applicant: TDK Corporation, Tokyo (JP)

(72) Inventors: Keigo HIGASHIDA, Tokyo (JP); Hironari GOSHIMA, Tokyo (JP)

(21) Appl. No.: 19/256,455

(22) Filed: Jul. 1, 2025

Related U.S. Application Data
(60) Provisional application No. 63/668,090, filed on Jul. 5, 2024.

(30) Foreign Application Priority Data
May 21, 2025 (JP) 2025-084841

(51) Int. Cl. H01F 27/28

(52) U.S. Cl. CPC H01F 27/28

(57) ABSTRACT

Disclosed herein is an electronic component that includes a first metal frame embedded in the element body having first and second surfaces. The first metal frame includes: a first section; a second section; a third section connected between a first end of the first section and a third end of the second section; a fourth section connected to a second end of the first section; and a fifth section connected to a fourth end of the second section. The first section and the second section are arranged in a second direction perpendicular to the first direction such that the first section and the second section cross each other when viewed from the second direction.

### CROSS-REFERENCE TO RELATED APPLICATION

This application claims the benefit of U.S. Provisional Patent Application No. 63/668,090, filed on Jul. 5, 2024, and Japanese Patent Application No. 2025-084841, filed on May 21, 2025, the entire disclosures of which are incorporated by reference herein.

### BACKGROUND OF THE ART

### Field of the Art

The present disclosure relates to an electronic component and, more particularly, to an electronic component having a structure in which a metal frame is embedded in an element body.

### Description of Related Art

JP 2022-151206A discloses an electronic component having a structure in which a metal frame that has been subjected to bending is embedded in an element body.

The inductor disclosed in JP 2022-151206A is a surface-mount type electronic component.

### SUMMARY

The present disclosure describes an electronic component suitably being incorporated in a substrate for use.

An electronic component according to one aspect of the present disclosure includes: an element body having a first surface and a second surface opposite to the first surface in the first direction; and a first metal frame embedded in the element body. The first metal frame includes: a first section having a first end and a second end; a second section having a third end and a fourth end; a third section connected between the first end of the first section and the third end of the second section; a fourth section connected to the second end of the first section, a part of the fourth section being exposed on the first surface of the element body; and a fifth section connected to the fourth end of the second section, a part of the fifth section being exposed on the second surface of the element body. The first section and the second section are arranged in a second direction perpendicular to the first direction such that the first section and the second section cross each other when viewed from the second direction.

### BRIEF DESCRIPTION OF THE DRAWINGS

The above features and advantages of the present disclosure will be more apparent from the following description of some embodiments taken in conjunction with the accompanying drawings, in which:

FIGS. 1A and 1B are schematic transparent perspective views of an electronic component 100 according to an embodiment of the technology described herein as viewed in different directions;

FIGS. 2A and 2B are schematic perspective views for explaining the structure of the metal frame 110 as viewed in different directions;

FIGS. 3A and 3B are schematic perspective views for explaining the structure of the metal frame 120 as viewed in different directions;

FIG. 4A is a schematic transparent perspective view of sample A in which the angles formed by the areas 1135 and 1136 of the section 113 is 50°;

FIG. 4B is a schematic cross-sectional view illustrating a magnetic field intensity distribution obtained when current is made to flow in the sample A;

FIG. 5A is a schematic transparent perspective view of sample B in which the angles formed by the areas 1135 and 1136 of the section 113 is 60°;

FIG. 5B is a schematic cross-sectional view illustrating a magnetic field intensity distribution obtained when current is made to flow in the sample B;

FIG. 6A is a schematic transparent perspective view of sample C in which the angles formed by the areas 1135 and 1136 of the section 113 is 90°;

FIG. 6B is a schematic cross-sectional view illustrating a magnetic field intensity distribution obtained when current is made to flow in the sample C;

FIG. 7A is a schematic transparent perspective view of sample D in which the angles formed by the areas 1135 and 1136 of the section 113 is 120°;

FIG. 7B is a schematic cross-sectional view illustrating a magnetic field intensity distribution obtained when current is made to flow in the sample D;

FIG. 8A is a schematic transparent perspective view of sample E in which the angles formed by the areas 1135 and 1136 of the section 113 is 150°;

FIG. 8B is a schematic cross-sectional view illustrating a magnetic field intensity distribution obtained when current is made to flow in the sample E;

FIG. 9A is a schematic transparent perspective view of sample F in which the angles formed by the areas 1135 and 1136 of the section 113 is 180°;

FIG. 9B is a schematic cross-sectional view illustrating a magnetic field intensity distribution obtained when current is made to flow in the sample F;

FIG. 10A is a graph illustrating inductances and DC resistances (DCR) of the respective samples A to F; and

FIG. 10B is a table showing inductance and DC resistance values of the samples A to F and values of an index (nH/mOhm) defined by the ratio between the inductance and DC resistance thereof.

### DETAILED DESCRIPTION OF THE EMBODIMENTS

Some embodiments of the present disclosure will be explained below in detail with reference to the accompanying drawings.

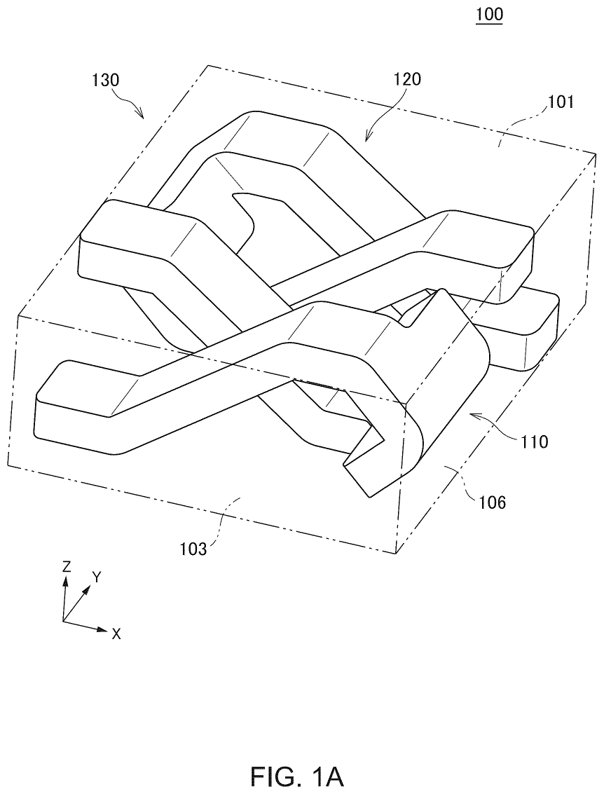

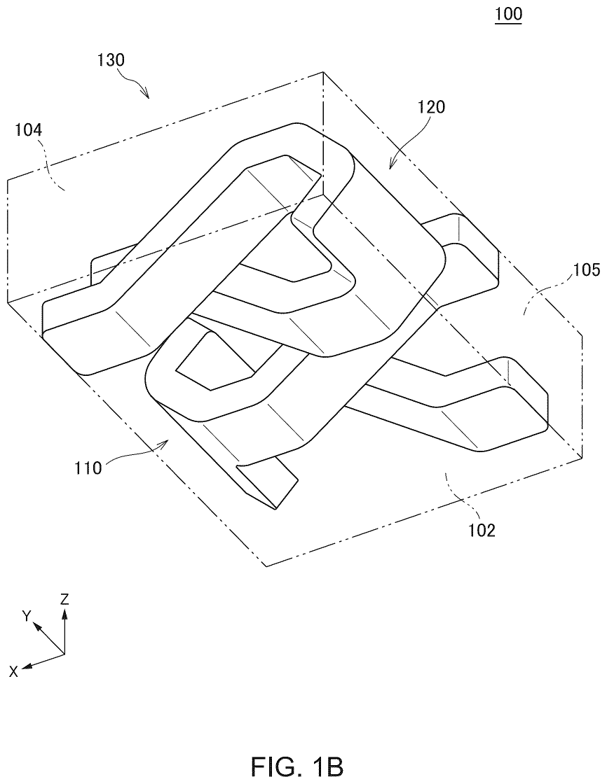

FIGS. 1A and 1B are schematic transparent perspective views of an electronic component 100 according to an embodiment of the technology described herein as viewed in different directions. Directional arrows indicating X-, Y-, and Z-axes are added in FIGS. 1A and 1B for descriptive convenience. In the following description, a direction indicated by each arrow is referred to as “positive direction”, and the opposite direction thereof is referred to as “negative direction” (the same applies to other drawings). In the present disclosure, the Z-, Y-, and X-directions are sometimes referred to as first, second, and third directions, respectively. Further, a plane extending in the X- and Y-directions is sometimes referred to as “XY plane”, a plane extending in the X- and Z-directions is sometimes referred to as “XZ plane”, and a plane extending in the Y- and Z-directions is sometimes referred to as “YZ plane”.

An electronic component 100 according to the present embodiment includes a magnetic element body 130 and metal frames 110 and 120 embedded in the magnetic element body 130. The metal frames 110 and 120 are arranged in the Y-direction in the magnetic element body 130. A coil conductor composed of the metal frames 110 and 120 has a coil axis extending in the Y-direction. The magnetic element body 130 may be made of a composite magnetic material obtained by binding, with binder resin, a magnetic filler made of a high-permeability material such as ferrite or permalloy. The magnetic element body 130 has main surfaces 101 and 102 constituting the XY plane and positioned on mutually opposite sides, side surfaces 103 and 104 constituting the XZ plane and positioned on mutually opposite sides, and side surfaces 105 and 106 constituting the YZ plane and positioned on mutually opposite sides.

The metal frames 110 and 120 are made of metal such as copper (Cu) and function as a coil conductor. For example, the metal frames 110 and 120 may be obtained by punching a flat metal sheet, followed by bending. In this case, the thickness of each of the metal frames 110 and 120 is substantially constant in each part. Further, the metal frames 110 and 120 may each be a seamless integral metal member.

As described above, the electronic component 100 according to the present embodiment uses bulk metal frames 110 and 120, so that a DC resistance is reduced as compared with when a coil conductor made of a plated film is used. Thus, the electronic component 100 according to the present embodiment can be used as an inductor for a power supply circuit. Further, although the metal frames 110 and 120 are arranged in the Y-direction (coil axis direction), they face mutually different directions by 180°, so that the coil conductor constituted by the metal frame 110 and the coil conductor constituted by the metal frame 120 exhibit a weak coupling.

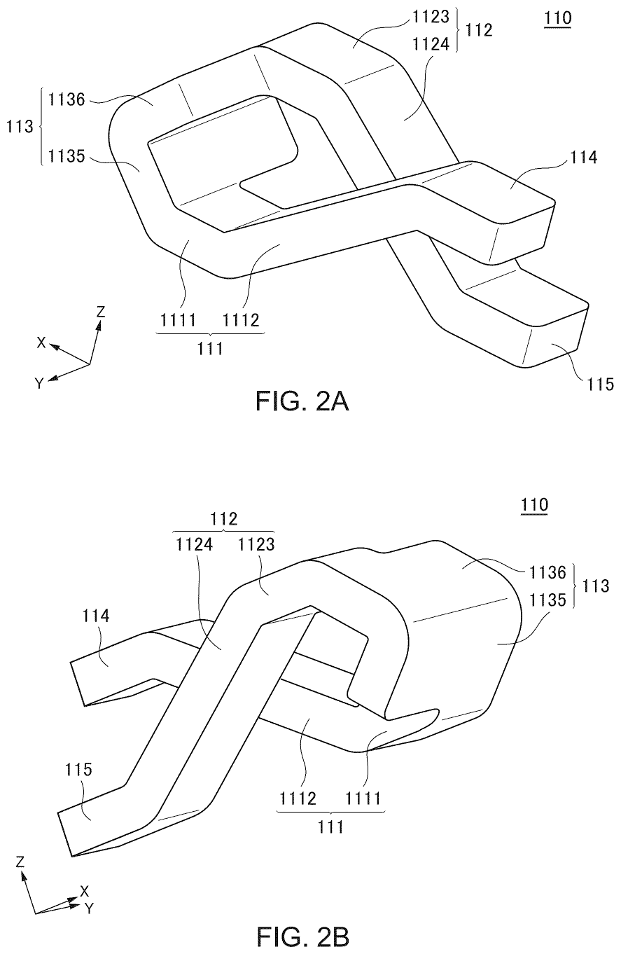

FIGS. 2A and 2B are schematic perspective views for explaining the structure of the metal frame 110 as viewed in different directions.

As illustrated in FIGS. 2A and 2B, the metal frame 110 has sections 111 and 112, a section 113 connecting an end portion of the section 111 in the positive X-direction and an end portion of the section 112 in the positive X-direction, a section 114 connected to an end portion of the section 111 in the negative X-direction, and a section 115 connected to an end portion of the section 112 in the negative X-direction.

The XY surface of the section 114 facing the positive Z-direction is exposed from the main surface 101 of the magnetic element body 130. The XY surface of the section 115 facing the negative Z-direction is exposed from the main surface 102 of the magnetic element body 130. The YZ surfaces of the sections 114 and 115 facing the negative X-direction may be exposed from the main surface 105 of the magnetic element body 130. The exposed surfaces of the section 114 constitute a first terminal electrode, and the exposed surfaces of the section 115 constitute a second terminal electrode.

The section 111 includes an area 1111 connected to the section 113 and an area 1112 connected to the section 114. The area 1111 of the section 111 extends in the X-direction, and the XY surface thereof facing the negative Z-direction may be exposed from the main surface 102 of the magnetic element body 130. The area 1112 of the section 111 obliquely extends at a predetermined angle with respect to the X-direction so as to linearly connect the section 114 and the area 1111 of the section 111. The area 1112 of the section 111 may be completely embedded in the magnetic element body 130 without being exposed therefrom.

The section 112 includes an area 1123 connected to the section 113 and an area 1124 connected to the section 115. The area 1123 of the section 112 extends in the X-direction, and the XY surface thereof facing the positive Z-direction may be exposed from the main surface 101 of the magnetic element body 130. The area 1124 of the section 112 obliquely extends at a predetermined angle with respect to the X-direction so as to linearly connect the section 115 and the area 1123 of the section 112. The area 1124 of the section 112 may be completely embedded in the magnetic element body 130 without being exposed therefrom.

The area 1112 of the section 111 and the area 1124 of the section 112 cross each other as viewed in the Y-direction.

The section 113 includes an area 1135 connected to the area 1111 of the section 111 and an area 1136 connected to the area 1123 of the section 112. The section 113 is bent at the boundary between the areas 1135 and 1136. The section 113 may be completely embedded in the magnetic element body 130 without being exposed therefrom. The width of the section 113 in the Y-direction may be larger than the widths of the sections 111, 112, 114, and 115 in the Y-direction. The widths of the sections 111, 112, 114, and 115 in the Y-direction may be the same as one another.

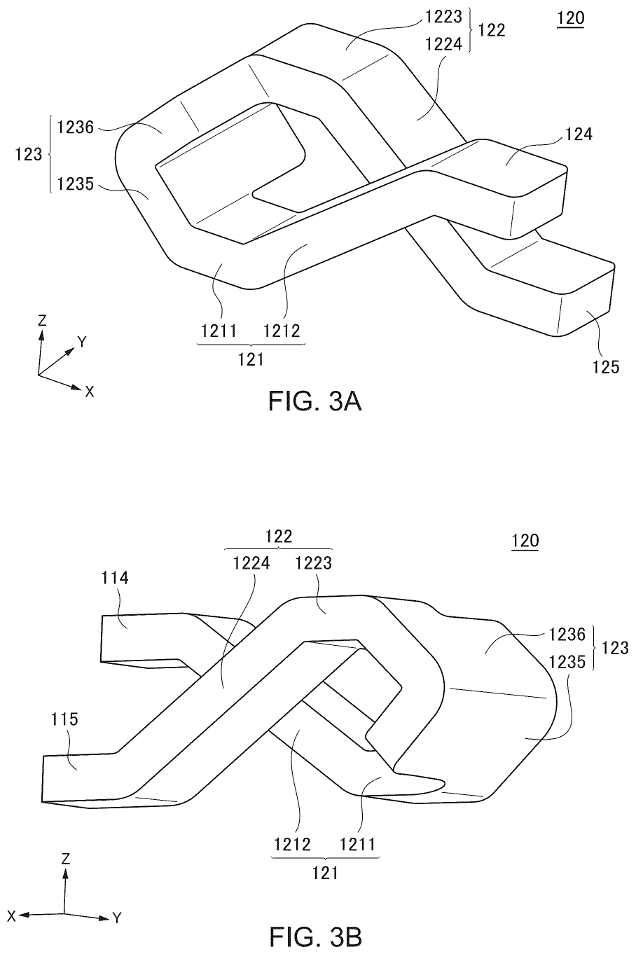

FIGS. 3A and 3B are schematic perspective views for explaining the structure of the metal frame 120 as viewed in different directions.

As illustrated in FIGS. 3A and 3B, the metal frame 120 has sections 121 and 122, a section 123 connecting an end portion of the section 121 in the negative X-direction and an end portion of the section 122 in the negative X-direction, a section 124 connected to an end portion of the section 121 in the positive X-direction, and a section 125 connected to an end portion of the section 122 in the positive X-direction.

The XY surface of the section 124 facing the positive Z-direction is exposed from the main surface 101 of the magnetic element body 130. The XY surface of the section 125 facing the negative Z-direction is exposed from the main surface 102 of the magnetic element body 130. The YZ surfaces of the sections 124 and 125 facing the positive X-direction may be exposed from the main surface 106 of the magnetic element body 130. The exposed surfaces of the section 124 constitute a third terminal electrode, and the exposed surfaces of the section 125 constitute a fourth terminal electrode.

The section 121 includes an area 1211 connected to the section 123 and an area 1212 connected to the section 124. The area 1211 of the section 121 extends in the X-direction, and the XY surface thereof facing the negative Z-direction may be exposed from the main surface 102 of the magnetic element body 130. The area 1212 of the section 121 obliquely extends at a predetermined angle with respect to the X-direction so as to linearly connect the section 124 and the area 1211 of the section 121. The area 1212 of the section 121 may be completely embedded in the magnetic element body 130 without being exposed therefrom.

The section 122 includes an area 1223 connected to the section 123 and an area 1224 connected to the section 125. The area 1223 of the section 122 extends in the X-direction, and the XY surface thereof facing the positive Z-direction may be exposed from the main surface 101 of the magnetic element body 130. The area 1224 of the section 122 obliquely extends at a predetermined angle with respect to the X-direction so as to linearly connect the section 125 and the area 1223 of the section 122. The area 1224 of the section 122 may be completely embedded in the magnetic element body 130 without being exposed therefrom.

The area 1212 of the section 121 and the area 1224 of the section 122 cross each other as viewed in the Y-direction.

The section 123 includes an area 1235 connected to the area 1211 of the section 121 and an area 1236 connected to the area 1223 of the section 122. The section 123 is bent at the boundary between the areas 1235 and 1236. The section 123 may be completely embedded in the magnetic element body 130 without being exposed therefrom. The width of the section 123 in the Y-direction may be larger than the widths of the sections 121, 122, 124, and 125 in the Y-direction. The widths of the sections 121, 122, 124, and 125 in the Y-direction may be the same as one another.

The metal frames 110 and 120 may have the same structure. In this case, the area 1112 of the section 111 of the metal frame 110 and the area 1224 of the section 122 of the metal frame 120 are parallel to each other, and the area 1124 of the section 112 of the metal frame 110 and the area 1212 of the section 121 of the metal frame 120 are parallel to each other.

The metal frames 110 and 120 having such a structure are arranged in the Y-direction inside the magnetic element body 130, as illustrated in FIGS. 1A and 1B so as to be disposed at positions different in direction by 180° with respect to the Y-direction. The section 114 of the metal frame 110 and the section 124 of the metal frame 120 can be used as a pair of input terminals, and the section 115 of the metal frame 110 and the section 125 of the metal frame 120 can be used as a pair of output terminals. The electronic component 100 according to the present embodiment is suitably incorporated in a substrate for use. For example, in a state where the electronic component 100 according to the present embodiment is embedded in a substrate composed of a plurality of insulating layers stacked in the Z-direction, the first and third terminal electrodes exposed from the main surface 101 of the magnetic element body 130 and the second and fourth terminal electrodes exposed from the main surface 102 of the magnetic element body 130 can be connected with a wiring pattern provided in the substrate.

When the area 1111 of the section 111 of the metal frame 110 is exposed from the main surface 102 of the magnetic element body 130, the surface of the section 111 may be used as a heat radiation terminal. When the area 1211 of the section 121 of the metal frame 120 is exposed from the main surface 102 of the magnetic element body 130, the surface of the section 121 may be used as a heat radiation terminal. A wiring pattern connected to the heat radiation terminal may be terminated without being connected to a power supply wiring or a signal wiring.

The surfaces of the sections 112 and 114 of the metal frame 110 that are exposed from the main surface 101 of the magnetic element body 130 may constitute the same plane. The surfaces of the sections 111 and 115 of the metal frame 110 that are exposed from the main surface 102 of the magnetic element body 130 may constitute the same plane. The surfaces of the sections 122 and 124 of the metal frame 120 that are exposed from the main surface 101 of the magnetic element body 130 may constitute the same plane. The surfaces of the sections 121 and 125 of the metal frame 120 that are exposed from the main surface 102 of the magnetic element body 130 may constitute the same plane.

The electronic component 100 having the above configuration is manufactured as follows: in a state where the metal frames 110 and 120 are placed on a support such that the sections 111 and 115 of the metal frame 110 contact the surface of the support and that the sections 121 and 125 of the metal frame 120 contact the surface of the support, the metal frames 110 and 120 are embedded in the magnetic element body 130. As a result, the metal frames 110 and 120 each contact the support surface at two points and can thus be stably supported on the support surface, thereby facilitating the manufacture of the electronic component 100. In addition, when the surfaces of the sections 111 and 115 exposed from the main surface 102 of the magnetic element body 130 constitute the same plane, and the surfaces of the sections 121 and 125 exposed from the main surface 102 of the magnetic element body 130 constitute the same plane, the metal frames 110 and 120 can be placed more stably on the support.

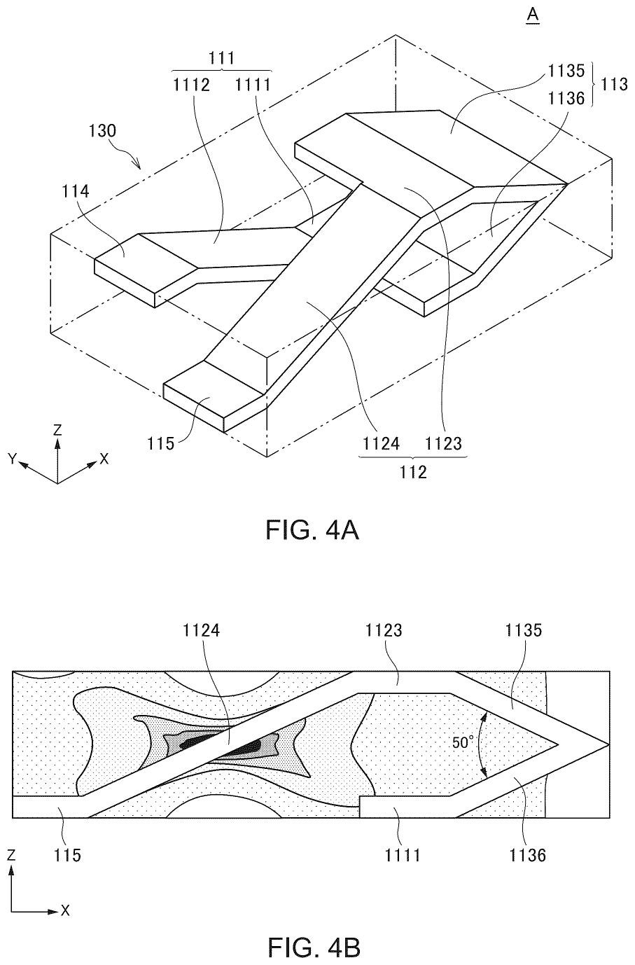

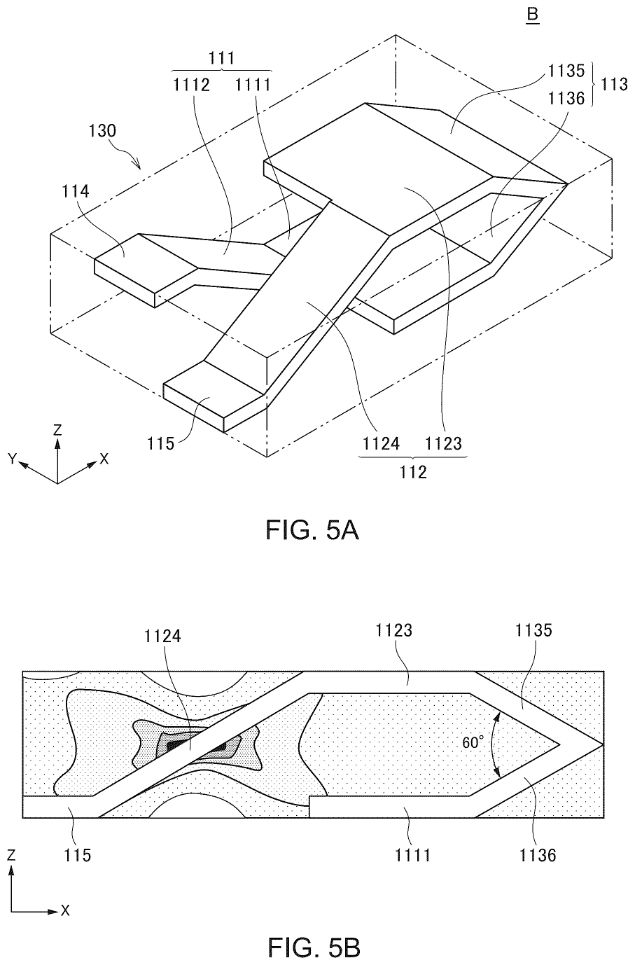

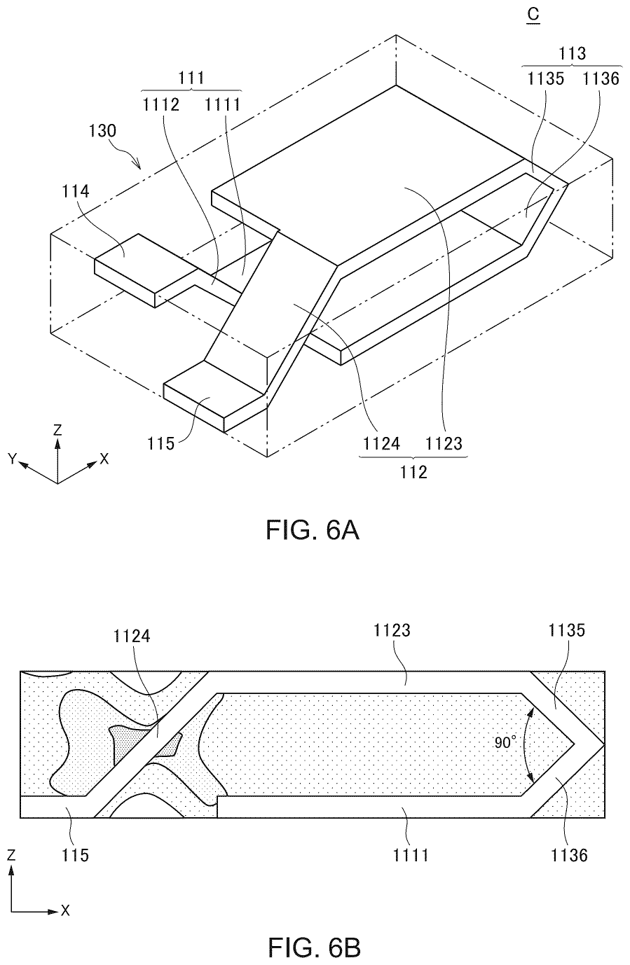

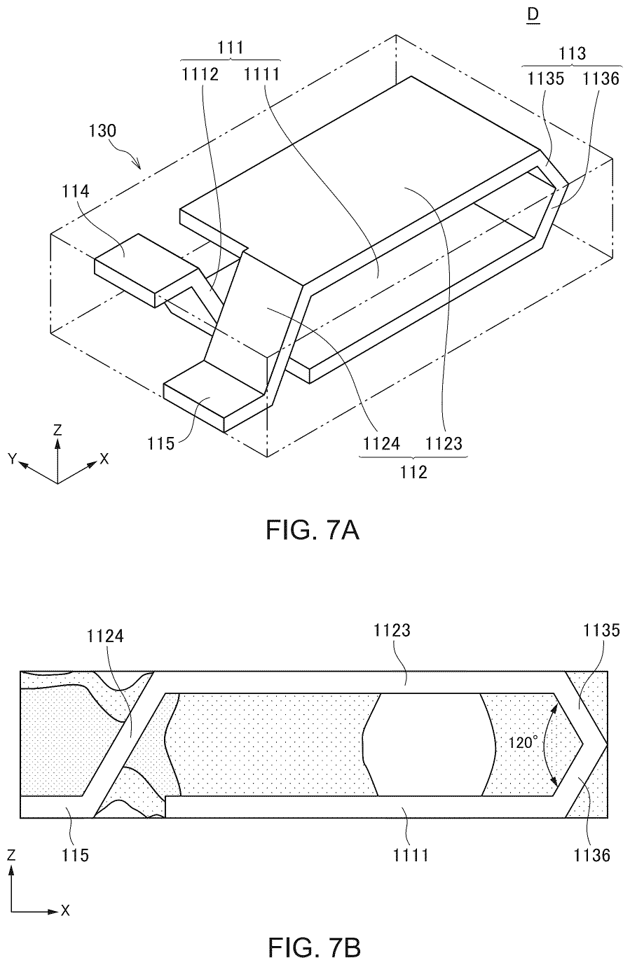

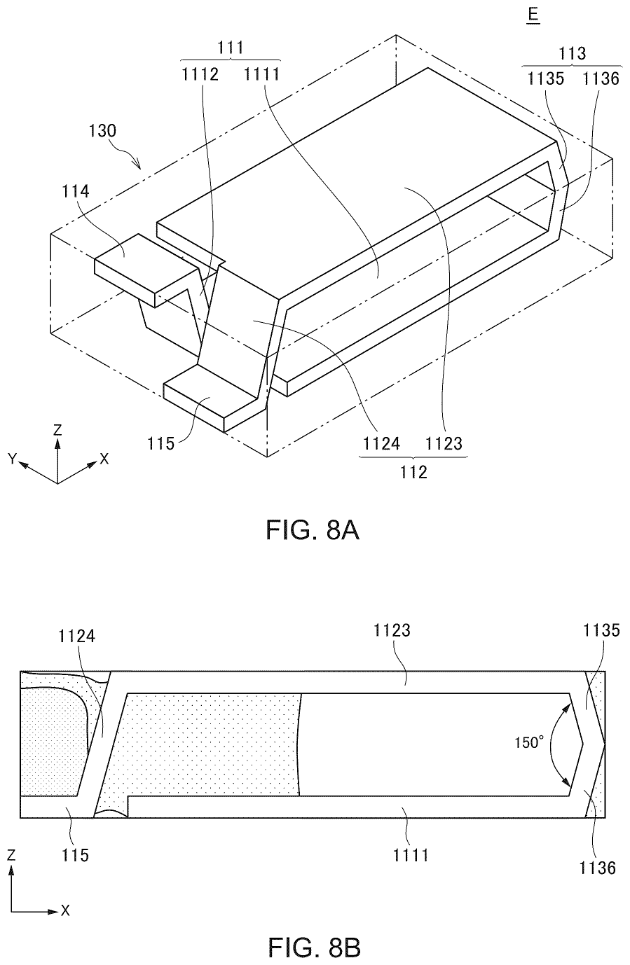

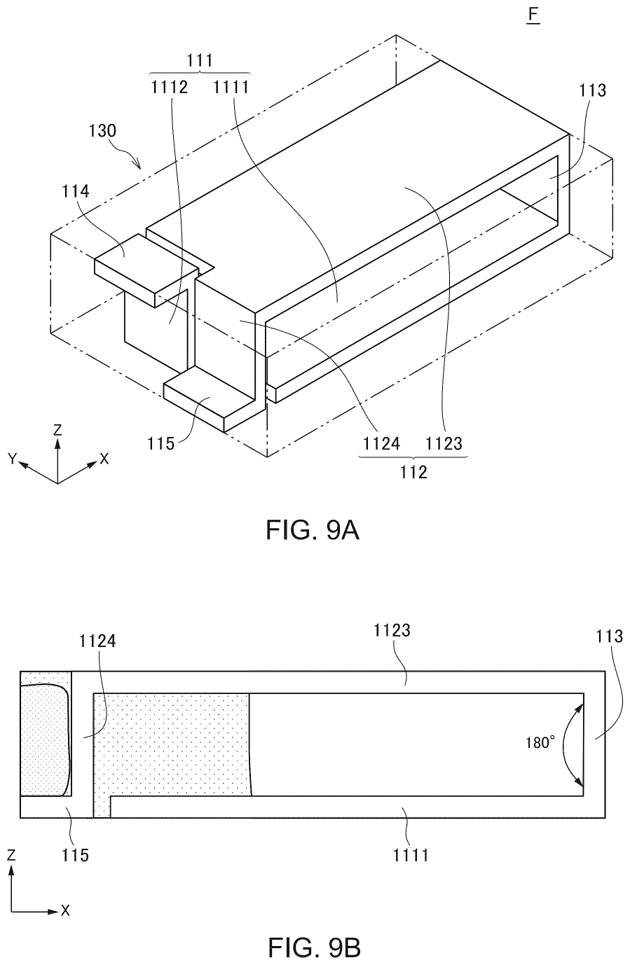

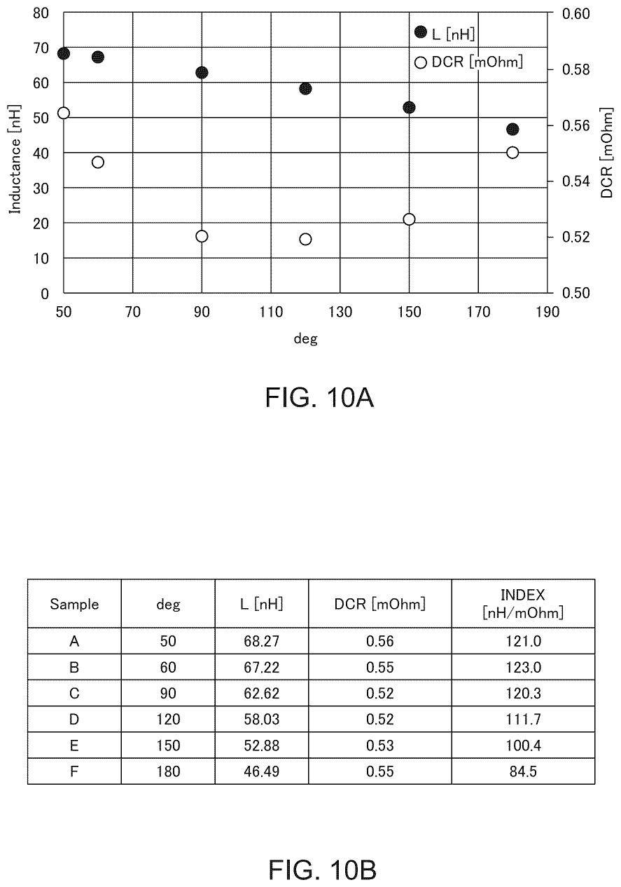

FIGS. 4A, 5A, 6A, 7A, 8A, and 9A are respectively schematic transparent perspective views of samples A to F in which the angles formed by the areas 1135 and 1136 of the section 113 are respectively 50°, 60°, 90°, 120°, 150°, and 180°. FIGS. 4B, 5B, 6B, 7B, 8B, and 9B are respectively schematic cross-sectional views illustrating magnetic field intensity distributions obtained when current is made to flow in the samples A to F. FIG. 10A is a graph illustrating inductances and DC resistances (DCR) of the respective samples A to F.

As illustrated in FIGS. 4A, 5A, 6A, 7A, 8A, and 9A, in each of the samples A to F, the width of the area 1111 of the section 111 in the Y-direction is larger than the width of the area 1112 of the section 111 in the Y-direction, and the width of the area 1123 of the section 112 in the Y-direction is larger than the width of the area 1124 of the section 112 in the Y-direction. The widths of the areas 1111 and 1123 in the Y-direction are the same as the width of the section 113 in the Y-direction. By thus widening the widths of the areas 1111 and 1123 in the Y-direction, it is possible to reduce the DC resistance and to enhance heat dissipation characteristics.

As illustrated in FIG. 10A, the inductances of the samples A to F increase as the angle formed by the areas 1135 and 1136 of the section 113 decreases. The DC resistances of the samples A to F decrease as the angle formed by the areas 1135 and 1136 of the section 113 increases in an area where the angle formed by the areas 1135 and 1136 is 90° or less; on the other hand, the DC resistances of the samples A to F increase as the angle formed by the areas 1135 and 1136 of the section 113 increases in an area where the angle formed by the areas 1135 and 1136 is 120° or more. This is because, in the area where the angle formed by the areas 1135 and 1136 of the section 113 is 90° or less, a decrease in the DC resistance due to an increase in the areas of the areas 1111 and 1123 becomes more dominant as the angle formed by the areas 1135 and 1136 increases, whereas in the area where the angle formed by the areas 1135 and 1136 of the section 113 is 120° or more, an increase in the DC resistance due to an increase in the length between the sections 114 and 115 becomes more dominant as the angle formed by the areas 1135 and 1136 increases.

FIG. 10B is a table showing inductance and DC resistance values of the samples A to F and values of an index (nH/mOhm) defined by the ratio between the inductance and DC resistance thereof. The index value becomes larger as the inductance is greater and as the DC resistance is lower. The index value exceeds 120 in an area where the angle formed by the areas 1135 and 1136 of the section 113 is 50° or more and 90° or less and becomes maximum when the angle formed by the areas 1135 and 1136 of the section 113 is 60°.

While some embodiments of the technology according to the present disclosure have been described, the technology according to the present disclosure is not limited to the above embodiments, and various modifications may be made within the scope of the present disclosure, and all such modifications are included in the technology according to the present disclosure.

For example, although the metal frames 110 and 120 are embedded in the magnetic element body 130 in the electronic component 100 according to the above embodiment, they may be embedded in a non-magnetic element body.

The technology according to the present disclosure includes the following configuration examples, but not limited thereto.

An electronic component according to one aspect of the present disclosure includes: an element body having a first surface and a second surface opposite to the first surface in the first direction; and a first metal frame embedded in the element body. The first metal frame includes: a first section having a first end and a second end; a second section having a third end and a fourth end; a third section connected between the first end of the first section and the third end of the second section; a fourth section connected to the second end of the first section, a part of the fourth section being exposed on the first surface of the element body; and a fifth section connected to the fourth end of the second section, a part of the fifth section being exposed on the second surface of the element body. The first section and the second section are arranged in a second direction perpendicular to the first direction such that the first section and the second section cross each other when viewed from the second direction. This makes it possible to expose both ends of the first metal frame, whose coil axis is in the second direction, from surfaces of the element body that are located on opposite sides.

In the above electronic component, the first section may include a first portion having the first end and a second portion having the second end, and a part of the first portion of the first section may be exposed on the second surface of the element body. This allows the first portion of the first section exposed from the second surface of the element body to be used as a heat dissipation terminal.

In the above electronic component, the first portion of the first section may extend in a third direction perpendicular to the first and second directions, and the second portion of the first section may extend in a fourth direction oblique to the third direction. This makes it possible to reduce the DC resistance of the first metal frame.

In the above electronic component, the second section may include a third portion having the third end and a fourth portion having the fourth end, and a part of the third portion of the second section may be exposed on the first surface of the element body. This allows the third portion of the second section exposed from the first surface of the element body to be used as a heat dissipation terminal.

In the above electronic component, the third portion of the second section may extend in the third direction, and the fourth portion of the second section may extend in a fifth direction oblique to the third direction. This makes it possible to reduce the DC resistance of the first metal frame.

In the above electronic component, a width of the third section in the second direction may be greater than a width of the second portion the first section. This makes it possible to reduce the DC resistance of the first metal frame.

In the above electronic component, a width of the first portion the first section is greater than a width of the second portion the first section. This makes it possible to reduce the DC resistance of the first metal frame.

In the above electronic component, a width of the first portion the first section may be the same as a width of the third section. This makes it possible to reduce the DC resistance of the first metal frame.

In the above electronic component, the third section may include a fifth portion connected to the first end of the first section and a sixth portion connected to the third end of the second section, and the third section may be bent at a boundary between the fifth portion and the sixth portion. This makes it possible to reduce the DC resistance of the first metal frame.

In the above electronic component, an angle between the fifth portion and the sixth portion is 50 degrees or more and 90 degrees or less. This makes it possible to increase the inductance of the first metal frame while reducing the DC resistance of the first metal frame.

The above electronic component may further include a second metal frame embedded in the element body. The second metal frame may include: a first section having a first end and a second end; a second section having a third end and a fourth end; a third section connected between the first end of the first section and the third end of the second section; a fourth section connected to the second end of the first section, a part of the fourth section being exposed on the first surface of the element body; and a fifth section connected to the fourth end of the second section, a part of the fifth section being exposed on the second surface of the element body. The first section of the second metal frame and the second section of the second metal frame are arranged in the second direction such that the first section of the second metal frame and the second section of the second metal frame cross each other when viewed from the second direction. The first metal frame and the second metal frame are arranged in the second direction. This makes it possible to provide an inductor array including a plurality of metal frames.

In the above electronic component, the first section of the second metal frame may include a first portion having the first end and a second portion having the second end, the second section of the second metal frame may include a third portion having the third end and a fourth portion having the fourth end, a part of the first portion of the first section of the second metal frame may be exposed on the second surface of the element body, a part of the third portion of the second section of the second metal frame may be exposed on the first surface of the element body, the first portion of the first section of the second metal frame may extend in the third direction, the second portion of the first section of the second metal frame may extend in the fifth direction, the third portion of the second section of the second metal frame may extend in the third direction, and the fourth portion of the second section of the second metal frame may extend in the fourth direction. This makes it possible to suppress a magnetic coupling between the first metal frame and the second metal frame.

In the above electronic component, the first and second metal frames may be the same in structure as each other. This eliminates the need to separately fabricate the first and second metal frames.

What is claimed is:

1. An apparatus comprising:
an element body having a first surface and a second surface opposite to the first surface in the first direction; and
a first metal frame embedded in the element body,
wherein the first metal frame includes:
a first section having a first end and a second end;
a second section having a third end and a fourth end;
a third section connected between the first end of the first section and the third end of the second section;
a fourth section connected to the second end of the first section, a part of the fourth section being exposed on the first surface of the element body; and
a fifth section connected to the fourth end of the second section, a part of the fifth section being exposed on the second surface of the element body,
wherein the first section and the second section are arranged in a second direction perpendicular to the first direction such that the first section and the second section cross each other when viewed from the second direction.

2. The apparatus of claim 1,
wherein the first section includes a first portion having the first end and a second portion having the second end, and
wherein a part of the first portion of the first section is exposed on the second surface of the element body.

3. The apparatus of claim 2,
wherein the first portion of the first section extends in a third direction perpendicular to the first and second directions, and
wherein the second portion of the first section extends in a fourth direction oblique to the third direction.

4. The apparatus of claim 3,
wherein the second section includes a third portion having the third end and a fourth portion having the fourth end, and
wherein a part of the third portion of the second section is exposed on the first surface of the element body.

5. The apparatus of claim 4,
wherein the third portion of the second section extends in the third direction, and
wherein the fourth portion of the second section extends in a fifth direction oblique to the third direction.

6. The apparatus of claim 2, wherein a width of the third section in the second direction is greater than a width of the second portion the first section.

7. The apparatus of claim 6, wherein a width of the first portion the first section is greater than a width of the second portion the first section.

8. The apparatus of claim 7, wherein a width of the first portion the first section is the same as a width of the third section.

9. The apparatus of claim 1,
wherein the third section includes a fifth portion connected to the first end of the first section and a sixth portion connected to the third end of the second section, and
wherein the third section is bent at a boundary between the fifth portion and the sixth portion.

10. The apparatus of claim 9, wherein an angle between the fifth portion and the sixth portion is 50 degrees or more and 90 degrees or less.

11. The apparatus of claim 5, further comprising a second metal frame embedded in the element body,
wherein the second metal frame includes:
a first section having a first end and a second end;
a second section having a third end and a fourth end;
a third section connected between the first end of the first section and the third end of the second section;
a fourth section connected to the second end of the first section, a part of the fourth section being exposed on the first surface of the element body; and
a fifth section connected to the fourth end of the second section, a part of the fifth section being exposed on the second surface of the element body,
wherein the first section of the second metal frame and the second section of the second metal frame are arranged in the second direction such that the first section of the second metal frame and the second section of the second metal frame cross each other when viewed from the second direction, and
wherein the first metal frame and the second metal frame are arranged in the second direction.

12. The apparatus of claim 11,
wherein the first section of the second metal frame includes a first portion having the first end and a second portion having the second end,
wherein the second section of the second metal frame includes a third portion having the third end and a fourth portion having the fourth end,
wherein a part of the first portion of the first section of the second metal frame is exposed on the second surface of the element body,
wherein a part of the third portion of the second section of the second metal frame is exposed on the first surface of the element body,
wherein the first portion of the first section of the second metal frame extends in the third direction,
wherein the second portion of the first section of the second metal frame extends in the fifth direction,
wherein the third portion of the second section of the second metal frame extends in the third direction, and
wherein the fourth portion of the second section of the second metal frame extends in the fourth direction.

13. The apparatus of claim 12, wherein the first and second metal frames are the same in structure as each other.
